(19) United States
(12) Patent Application Publication
(10) Pub. No.: US 2007/0143142 A1
(43) Pub. Date: Jun. 21, 2007

(54) Patient Medication History Management System

(75) Inventors: Paul Villasenor, Newark, DE (US); Jane E. Marlatt, Linfield, PA (US); Joseph Piccerillo JR., Phoenixville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS HEALTH SERVICES CORPORATION, MALVERN, PA (US)

(21) Appl. No.: 11/608,893

(22) Filed: Dec. 11, 2006

Related U.S. Application Data
(60) Provisional application No. 60/829,064, filed on Oct. 11, 2006.
(60) Provisional application No. 60/751,221, filed on Dec. 16, 2005.

(51) Int. Cl. G06Q 50/00; G06Q 10/00

(52) U.S. Cl. 705/2

(57) ABSTRACT

A medication information acquisition system facilitates collection and accurate consolidation of home medication history from data sources providing data of varying degrees of accuracy. A medication information acquisition system automatically acquires patient medication information from multiple different sources. The system includes an acquisition processor for, in response to user command, automatically interrogating multiple different information sources for acquiring and collating medication data to provide patient medication history data indicating medications a patient received prior to admission to a healthcare provider facility. The multiple different information sources include at least two of, (a) a pharmacy benefit management system, (b) a healthcare information system indicating medications a patient was receiving at the most recent time of discharge of the patient from a healthcare provider facility and (c) medication information derived by questioning the patient. A display processor initiates generation of data representing a display image identifying the medications the patient received prior to admission and enabling a user to individually select medications to be continued or canceled.

This is a non-provisional application of provisional application Ser. No. 60/829,064 by P. Villasenor et al. filed Oct. 11, 2006 and provisional application Ser. No. 60/751,221 by P. Villasenor et al. filed Dec. 16, 2005.

### FIELD OF THE INVENTION

This invention concerns a medication information acquisition system for automatically acquiring patient medication information from multiple different sources for reconciliation with a medication reconciliation system to provide a consolidated list of medications.

### BACKGROUND OF THE INVENTION

In existing systems, when a patient appears at a hospital, part of the medical history gathered includes data indicating the medications currently and previously being taken by the patient. If the patient has a complex medication list or has difficulty recalling medications being taken or previously taken, gathering this information can prove challenging. Further, depending on the care setting, one or more lists of medications may be available in a hospital records system. However, sorting through medication lists with multiple duplicates is time consuming and prone to errors.

Typically sources of medication history information have been limited and involved non-electronic paper based sources, for example. Thus existing systems typically involve collecting a complete medication history by interviewing a patient and manually comparing lists of medications side by side. This medication list comparison is both time consuming and prone to error. This becomes more apparent as the lists get longer since duplicate medications and similar medications become harder to track. Existing systems also involve viewing available patient medication data on separate screens or reports either online or on paper and collecting home medication information of a patient by asking the patient for information indicating every medication the patient is taking and documenting the elicited information on paper. A system according to invention principles addresses these deficiencies and related problems.

### SUMMARY OF THE INVENTION

A medication information acquisition system facilitates collection and accurate consolidation of home medication history in an acute (and other) care setting from multiple different sources that provide data of varying accuracy including a hospital record, records external to a hospital system, a pharmacy benefit manager system, and the patient. A medication information acquisition system automatically acquires patient medication information from multiple different sources. The system includes an acquisition processor for, in response to user command, automatically interrogating multiple different information sources for acquiring and collating medication data to provide patient medication history data indicating medications a patient received prior to admission to a healthcare provider facility. The multiple different information sources include at least two of, (a) a pharmacy benefit management system, (b) a healthcare information system indicating medications a patient was receiving at the most recent time of discharge of the patient from a healthcare provider facility and (c) medication information derived by questioning the patient. A display processor initiates generation of data representing a display image identifying the medications the patient received prior to admission and enabling a user to individually select medications to be continued or canceled.

### BRIEF DESCRIPTION Of THE DRAWING

FIG. 1 shows a Hospital Information System (HIS) including a medication information acquisition system for automatically acquiring patient medication information for use in medication reconciliation, according to invention principles.

FIG. 2 shows a user interface display image showing patient medication information acquired from multiple different sources, according to invention principles.

FIG. 3 shows a user interface display image menu enabling a user to select new medications for addition to a current home medication list, according to invention principles.

FIG. 4 shows a user interface display image enabling a user to enter text concerning patient home medications, according to invention principles.

FIG. 5 shows a user interface display image enabling a user to identify and select medications from previously stored medication lists for use in compiling a home medications list, according to invention principles.

FIG. 6 shows a flowchart of a process used by a medication information acquisition system, according to invention principles.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, a context acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by the display processor under the control of the processor. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to the processor. The processor, under control of the executable procedure or executable application manipulates the UI display images in response to the signals received from the input devices. In this way, the user interacts with the display image using the input devices, enabling user interaction with the processor or other device.

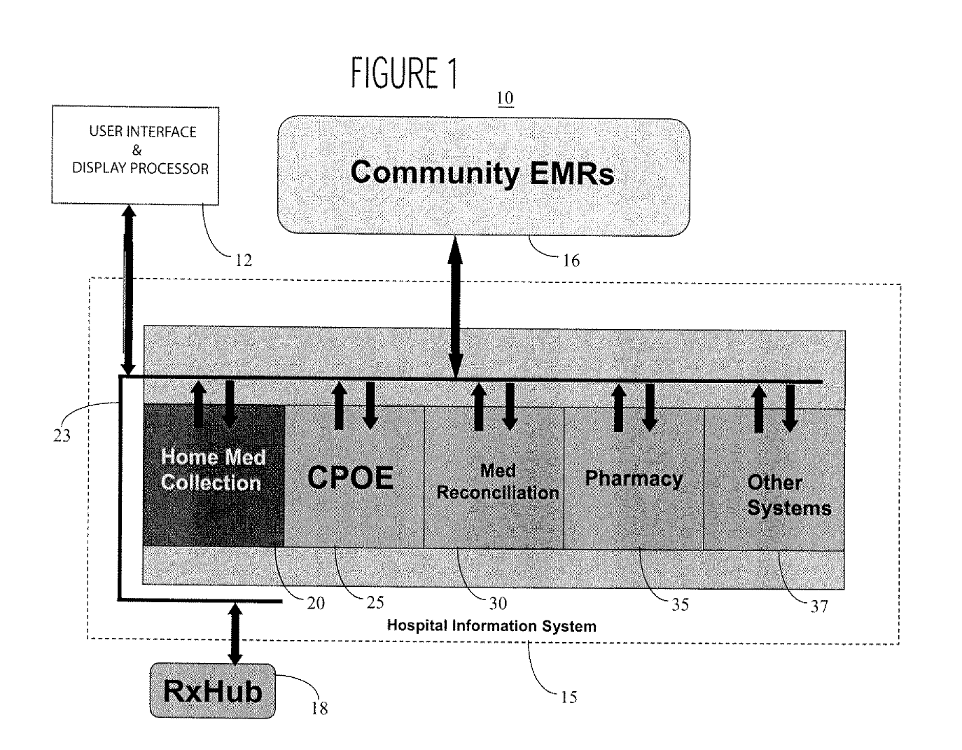

A medication information acquisition system 20 comprises an integrated home medication collection system in Hospital Information System (HIS) 10 illustrated in FIG. 1. Acquisition system 20 automatically acquires patient medication information comprising a patient home medication history from multiple sources and facilitates consolidation of the acquired information into a current, accurate medication list in one place, for example, for use in medication reconciliation. Acquisition system 20 initiates communication on network 23 (or another link) with multiple information sources using predetermined corresponding source specific communication link information. Acquisition system 20 interacts via network 23 with various applications and systems in HIS 10 including, pharmacy application 35, medication reconciliation application 30, Computerized Physician Order Entry application (CPOE) 25, pharmacy benefit management application 18, a workstation and user interface 12, repositories of electronic medical records 16 within a hospital or at facilities or remote organizations external to the hospital and other applications and systems 37. The other applications and systems 37 include electronic worklists provided by a workflow system., a scheduling application, an ADT (Admission, Discharge and Transfer) system, a workflow engine application, a clinical information system and personnel communication devices and applications, for example.

Acquisition system 20, in response to user command, automatically interrogates multiple different information sources internal and external to HIS 10 to acquire and collate medication data to provide patient medication history data indicating medications a patient received prior to admission to a healthcare provider facility. The multiple different information sources include at least two of, pharmacy benefit management system 18, a healthcare information system (internal and external patient record systems 16) indicating medications a patient was receiving at the most recent time of discharge of the patient from a healthcare provider facility and medication information derived by questioning the patient and entered via workstation and user interface 12. A display processor in workstation and user interface 12 initiates generation of data representing a display image identifying the medications the patient received prior to admission and enabling a user to individually select medications to be continued or canceled.

Acquisition system 20 is able to collect medication history as structured data (when it is available) so that medication information may be used more flexibly within system 10. System 20 streamlines and facilitates collection and accurate consolidation of home medication history in an acute (and other) care setting from multiple different sources providing data of varying accuracy including hospital records and external records 16, a prescription and pharmacy benefit manager system 18, and the patient. System 20 processes accuracy factors associated with acquired medication information including, age of the data, the original source of the data and reliability of the patient, for example, in estimating accuracy of the acquired medication information. System 20 provides data representing a consolidated list of home medications a patient was taking prior to admission to a hospital by including medications on the list with an estimated accuracy indicating likelihood a patient was taking the medication concerned exceeding a predetermined threshold (60 percent, for example). Thereby system 20 efficiently creates a current and accurate medication list based on available patient medication data.

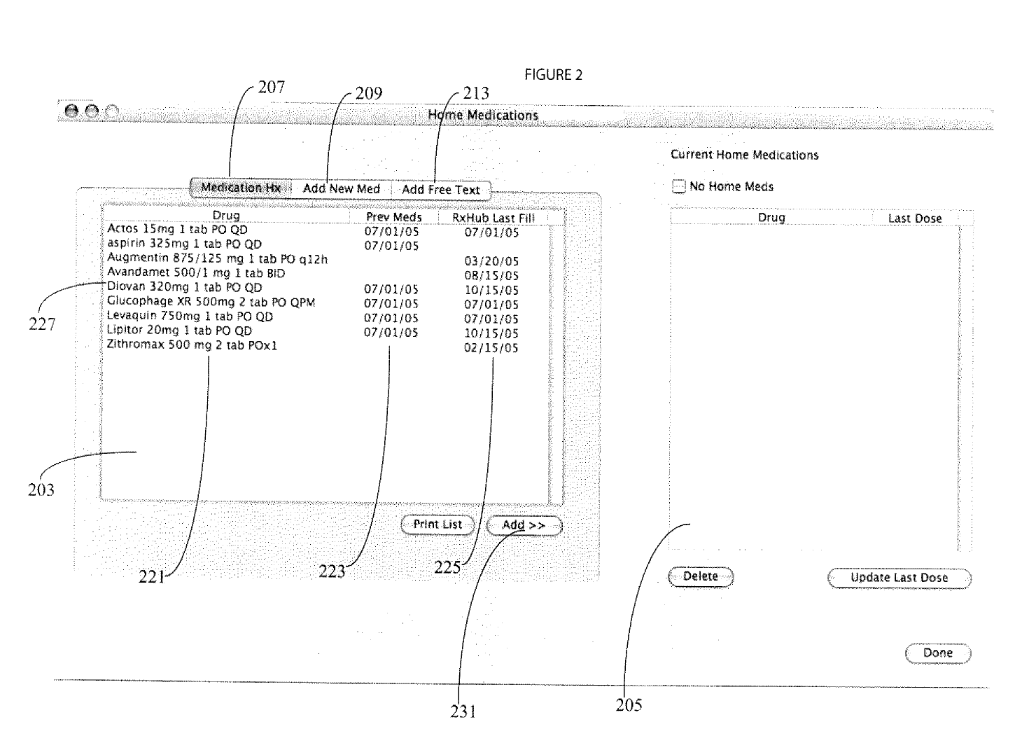

FIG. 2 shows a user interface display image showing patient medication information acquired by system 20 from multiple different sources. User interface 12 (FIG. 1) provides a functional screen consisting of two parts: a multi-section area 203 (FIG. 2) that contains multiple medication selection sources and an area 205 with a current list of home medications. Within multi-section area 203, there are options for selecting medications from prior stored medication histories 207, adding a medication to a home medication list from a catalog of medications 209, and free text entry of information 213 concerning a medication, Medication histories are stored in an HIS 10 database. This may include discharge medications recorded from a previous admission, prescription history from a Prescription Benefit Manager system 18 (FIG. 1) and medication history from an affiliated physician electronic medical record (EMR) 16. A medication reference database (for example, a National Drug Data File (NDDF) database by First Databank) in HIS 10 is used by acquisition processor 20 and user interface 12 for lookup of medications in response to user command and routine queries, for example. Additionally, a user is able to enter free text concerning medications which are not recorded in available patient records or concerning a medication name a patient is unable to remember (e.g., “a purple pill”).

In a stored medication history section (Medication Hx) 207 (shown in image area 203 in FIG. 2), acquisition processor 20 and user interface 12 displays medications available from different sources. A display provided by user interface 12 shows a consolidated list of medications, including medications derived from a prior patient medication history record stored in HIS 10 and including medications derived from previous discharge and medication information from pharmacy benefit manager system 18 (for example, from healthplan reimbursement related information provided by a pharmacy benefit manager (PBM) system 18). Since there are likely to be replicated medications derived from a patient medication history list and a pharmacy benefit manager list. any medication appearing on both lists identified and processed by system 10 so that a replicated medication is indicated once in a consolidated list on a display image provided by user interface 12 and inclusion of a medication in both lists is noted, e.g., in a display or in an audit record time and date stamped in processor 20. System 10 performs matching of data representing medications using a reference database (such as a NDDF database) to associate brand and generic names of the same medication together, for example.

Image area 203 (FIG. 2) shows a patient medication history (Medication Hx 207). Acquisition processor 20 acquires data identifying patient medications from a Previous Medications list (i.e., home medications prescribed for a patient upon a last hospital discharge, if applicable) as well as from a pharmacy benefit manager system 18 list and provides a consolidated list of medications in image area 203 including some medications from both lists. Columns 223 and 225 indicate the most recent dates that corresponding particular medications on respective medication lists were updated. Specifically, the date of Jul. 01, 2005 in previous medications column 223 comprises a discharge date on which a patient was discharged with corresponding medications from a discharge list indicated in column 221. Furthermore, dates in RxHub Last Fill column 225 comprise dates on which prescriptions for corresponding medications in column 221 were filled for a patient through a prescription plan. For example, row 227 indicates the patient was discharged from the hospital on Jul. 01, 2005 and instructed to take Diovan 320 mg 1 tab by mouth daily. and the patient most recently filled this prescription on Oct. 15, 2005. The display image of FIG. 2 provided by user interface 12 (FIG. 1) advantageously readily incorporates more sources of patient medication data. Acquisition processor 20, in one embodiment, determines a number of available medication data sources in HIS 10 for a given patient at time of application execution and dynamically creates a consolidated medication list and user interface display image. Acquisition processor 20 includes a repository including data indicating a list of multiple medication sources and enables a user to predetermine which sources are to be interrogated for a particular patient or type of patient in compiling a medication history list 207 based on one or more of, a user preference and a user selection command made at time of application execution.

A user adds a medication indicated in a medication history list 207 in column 221 to a current home medication list in image area 205 by selecting (e.g., highlighting with a mouse) a medication in column 221 and clicking Add button 231 to add the medication to the current home medication list in image area 205. A user is also able to select and add a new medication from a database of prescription, over-the-counter, and herbal medications to the current home medication list in image area 205 using a display menu initiated by user selection of item 209 (FIG. 2).

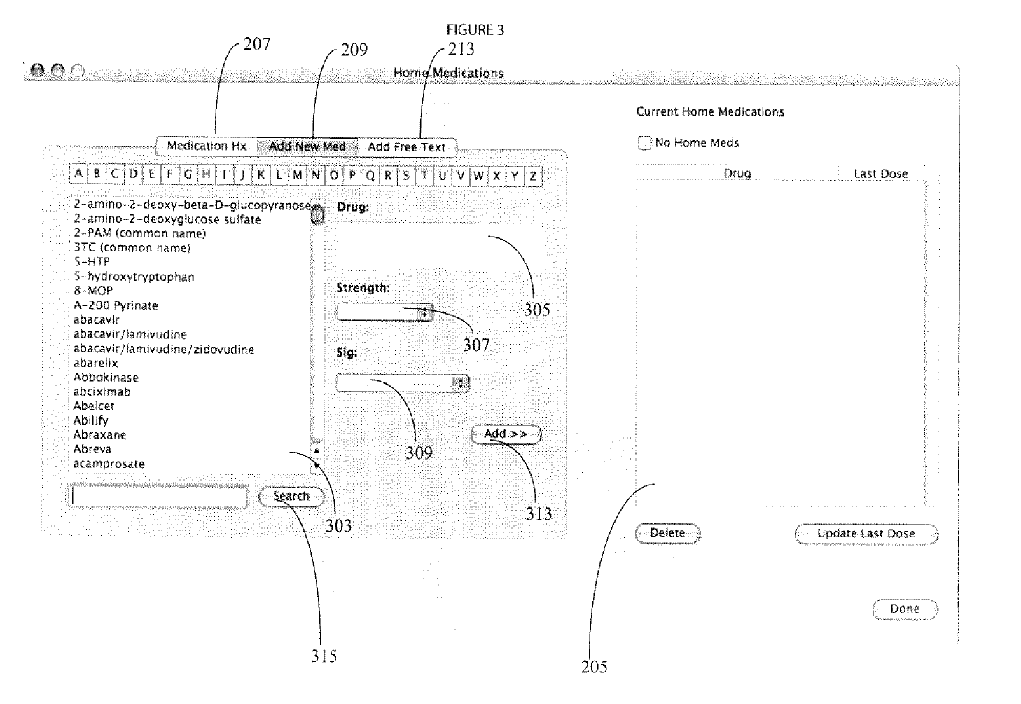

FIG. 3 shows a user interface display image menu enabling a user to select new medications for addition to a current home medication list presented in response to user selection of item 209 (FIG. 2). The new medications for addition comprise medications not previously recorded in medication history list 207 and in adding these medications to list 207, a user improves accuracy of medication information. Image area 303 of FIG. 3 shows alphabetically listed medications from a database of prescription, over-the-counter, and herbal medications that are individually selectable by a user and may be added to the current home medication list in image area 205 upon user selection of Add button 313. A user is able to enter a medication generic or other name, medication strength and prescription indicating route and frequency of administration in data fields 305, 307 and 309 respectively. A user is also able to initiate a search of the database to locate a desired medication in response to entry of a search term and initiation of a search via elements in row 315.

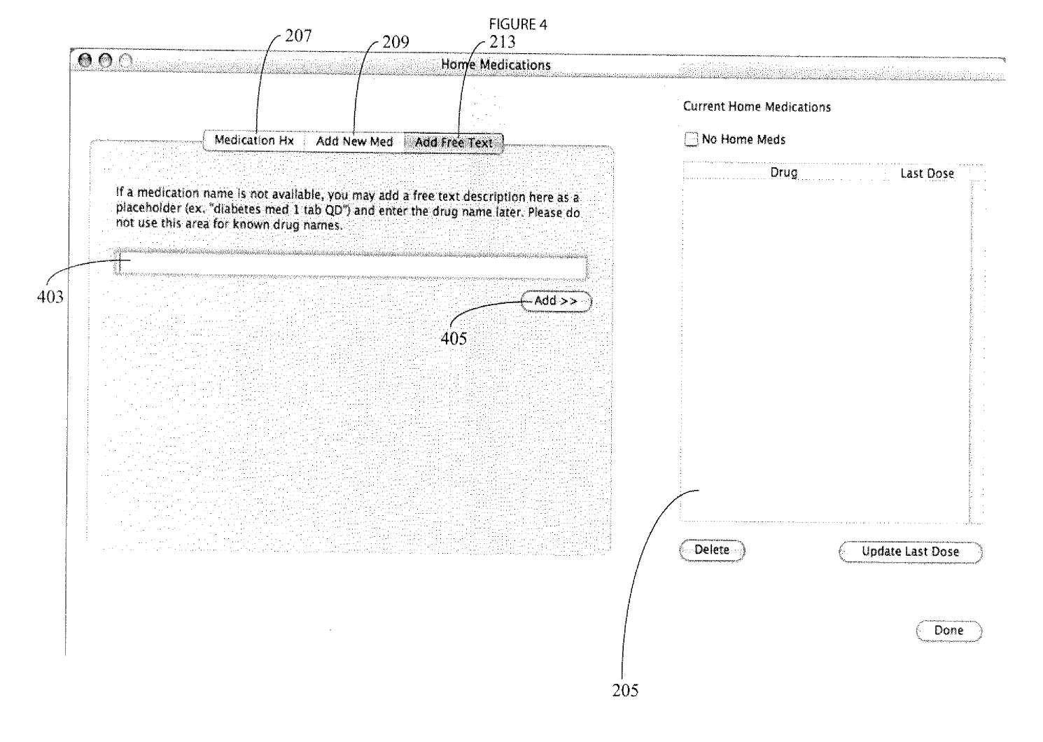

FIG. 4 shows a user interface display image enabling a user to enter text concerning patient home medications. This is used, for example, in a situation where a patient is taking a medication but does not know the name of the medication. The medication may be described as a “blue pill” or “water pill,” but this may be the full extent of patient recall concerning the medication. Rather than lose that information, a user is able to advantageously capture it using a user interface display image enabling a user to enter text concerning a patient home medication presented in response to user selection of item 213 (FIG. 2). A user enters text concerning a patient home medication in data field 403 and adds it to a current home medication list in image area 205 by selection of button 405. Acquisition processor 20 and user interface 12 advantageously provide three medication selection source image areas accessed via elements 207, 209 and 213 in a single image for use in providing a consolidated list of patient home medications. User interface 12 advantageously enables a user to navigate between the three medication selection source image areas (shown in FIGS. 2, 3 and 4) whilst concurrently keeping the current home medication list image area 205 in view.

Acquisition processor 20 in conjunction with user interface 12 in HIS 10 provides a completed home medication list to medication reconciliation application 30 and to Computerized Physician Order Entry application (CPOE) 25. Medication reconciliation application 30 enables a user to eliminate replicated medications, rationalize and consolidate medications, dosages and routes of administration and provide a single accurate medication list for a patient upon admission, care setting transfer or discharge from a hospital, for example. Acquisition processor 20 in conjunction with user interface 12 also provides a display image indicating hospital formulary status of patient home medications indicating whether a particular medication is on an approved list of medications of a healthcare plan of a patient. Acquisition processor 20 further identifies and provides alternative formulary candidate medications for non-formulary medications. Acquisition processor 20 also initiates generation of an alert message for communication to a clinician to alert a clinician that user entered text (e.g., via the FIG. 4 display image) concerning a medication needs investigation to discover the correct name of a medication being taken by a patient. Acquisition processor 20 and user interface 12 sort medication history lists in image areas 203 and 205 (FIG. 2) based on user predetermined preferences stored within a configuration repository in processor 20 and provide sorted medication lists for display in a FIG. 2 image, for example. Thereby a user sees more recently updated medications at the top of a medication history list. Further, in response to completion of a home medication list using display images of FIGS. 2, 3 and 4, acquisition processor 20 communicates a completed home medication list for storage within a patient medical record in HIS 10.

In operation of HIS 10, upon a patient being admitted to a hospital and as part of an admission process, acquisition processor 20 acquires data representing home medications of a patient (medications taken by the patient prior to admission) from multiple different sources. Medication histories are accessed by processor 20 from external sources 16 such as remote organizations (e.g. a pharmacy, medical imaging facilities, hospitals, physician practices, clinics etc.). External sources may also be accessed for other information during other medical system processes and procedures. A patient during admission may have a list of medications or a bag of medications available, or the patient may not know which medications he is taking. Acquisition processor 20 acquires data indicating medications a patient was previously taking upon discharge from a stay in a hospital from sources 16 via network 23. This acquired medication data may be treated as a starting point employed by a user using image displays FIGS. 2-4 in deriving a complete home medication list. Similarly, acquisition processor 20 acquires data indicating a patient medication refill history from pharmacy benefit manager system is or from external sources 16 such as a community physician network, clinic or other facility accessible on network 23. Patient medication data acquired from a community physician network may appear in an existing image area (e.g., area 203) or in an additional image area (not shown to preserve drawing clarity). A user is advantageously able to display an image indicating patient medical history (e.g., FIG. 2) while interviewing the patient. This enables the user to focus on verifying and updating the automatically acquired and presented information rather than manually building a home medication list from the beginning.

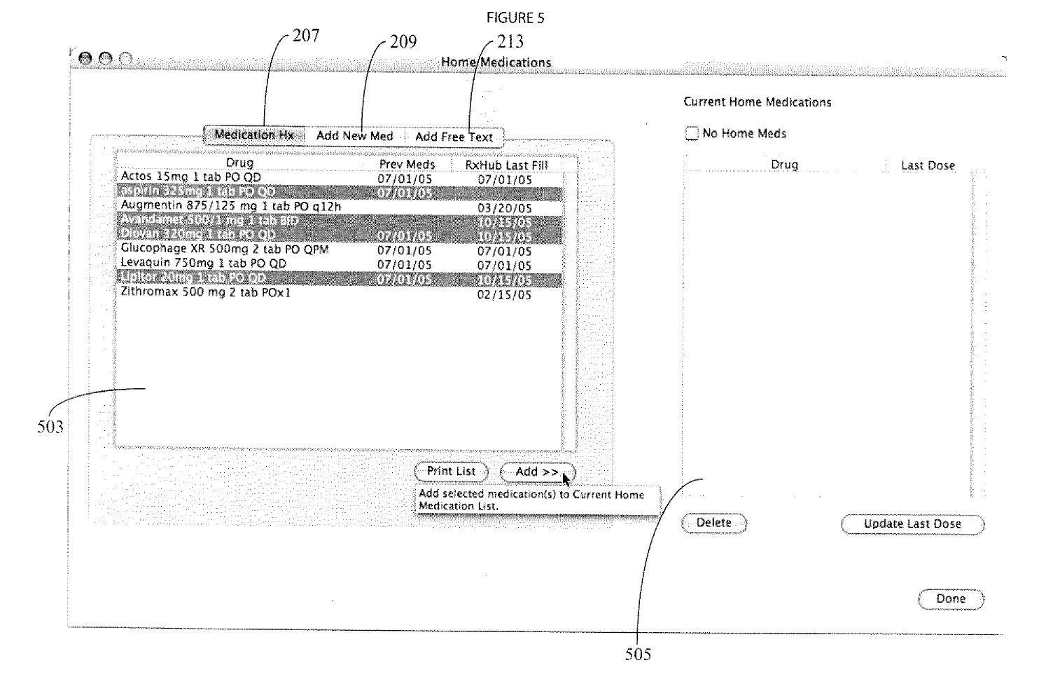

FIG. 5 shows a user interface display image enabling a user to identify and select medications from previously stored medication lists for use in compiling a home medications list. A user is able to add a new medication to a patient home medication list upon determination during interviewing the patient that the patient is taking a medication that is not on any of the previously stored medication lists illustrated in image area 503, for example. For this purpose, the user selects tab 209 (Add New Med) to add a medication not listed in the medication history in image area 503 (provided in response to selection of tab 207-Medication Hx) to a current home medication list in image area 505. A user is able to enter a medication related text description in response to selection of tab 213 as a placeholder with a visually distinct attribute until a corresponding actual medication name is ascertained.

HIS 10 indicates whether or not a patient has provided a complete list of medications and enables a user to enter pertinent medication related comments for user reference without affecting performance of medication reconciliation. The progress of compilation of a home medication list is also monitored by a workflow engine in unit 37 in HIS 10 to determine if progress is adequate or whether associated tasks need to be expedited by escalating task performance to a supervisory worker through related message communication via network 23, for example. The system also enables a user to indicate that a patient is not taking any home medications and that patient medication data was assessed but no home medications are associated with the patient. HIS 10 also displays and prints a list of home medications (usable as an order sheet for physicians) including a complete or incomplete status of home medication data collection and review. This list is available to clinicians participating in a patient medication management process (such as physicians, nurses, pharmacists).

HIS 10 also enables a pharmacist to access data indicating patient home medications from within a Pharmacy Management Executable Application and indicates if any home medications should be continued or discontinued in hospital. HIS 10 enables a user to modify medication orders and substitute formulary alternatives for home medications and in one embodiment uses a workflow engine in unit 37 to automatically generate an alert message indicating that home medication data has not been collected within a predetermined time period following admission.

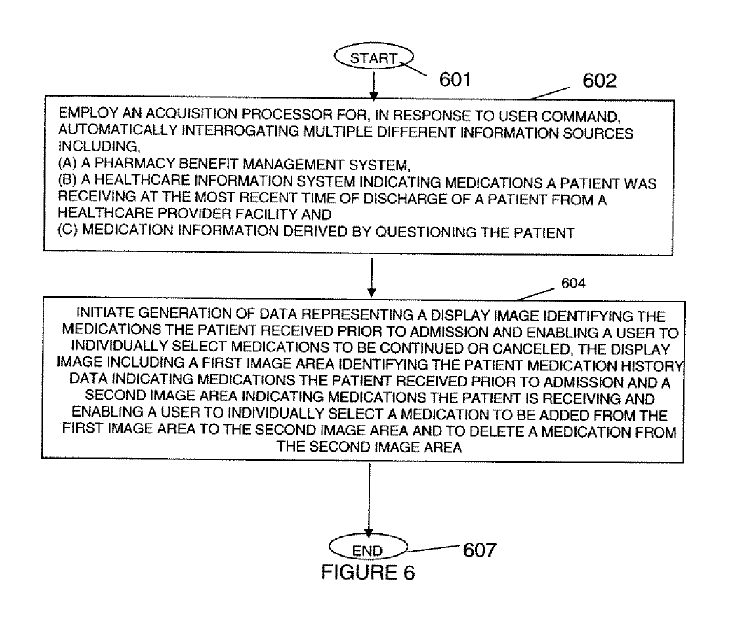

FIG. 6 shows a flowchart of a process used by a medication information acquisition system comprising acquisition processor 20 and user interface 12 (FIG. 1). In step 602 following the start at step 601, acquisition processor 20, in response to user command, automatically interrogates multiple different information sources to acquire and collate medication data and identifies and removes data (in response to user command or automatically or both) indicating replicated medications to provide a consolidated list of medications the patient received prior to admission to a healthcare provider facility. The multiple different information sources include, a pharmacy benefit management system, a healthcare information system indicating medications a patient was receiving at the most recent time of discharge of the patient from a healthcare provider facility and medication information derived by questioning the patient. The consolidated list of medications indicates a date on which a prescription for a corresponding medication was last filled and a last healthcare facility discharge date at which the patient was receiving a corresponding medication. Acquisition processor 20 identifies and removes the data indicating replicated medications by matching data identifying medications using a reference database associating brand and generic names of a medication.

In step 604 a display processor in user interface 12 initiates generation of data representing a display image identifying the medications the patient received prior to admission and enabling a user to individually select medications to be continued or canceled. The display image includes a first image area identifying the patient medication history data indicating medications the patient received prior to admission and a second image area indicating medications the patient is receiving The display image enables a user to individually select a medication to be added from. the first image area to the second image area and to delete a medication from the second image area. The display image further includes user selectable elements enabling a user to access and display in a first image area items including at least one of, (i) data identifying the patient medication history, (ii) data indicating candidate medications to add to medications the patient is receiving prior to admission and (iii) data supporting a user in capturing information provided by a patient concerning medications the patient is taking. The display image enables a user to navigate through the items in the first image area while advantageously concurrently displaying a second image area indicating medications the patient is receiving and enabling a user to individually select medication data to be added from the first image area to the second image area and delete a medication from the second image area.

Acquisition processor 20 sorts a list of candidate medications that are available to be added to medications the patient is receiving prior to admission in response to predetermined sorting criteria to provide a sorted medication list. A display image provided by user interface 12 indicates the sorted medications and includes data fields enabling a user to search a list of candidate medications available to add to medications the patient is receiving prior to admission in response to user entered search criteria. The display image includes data fields enabling a user to enter data indicating a drug name, a drug strength and a prescription. The prescription indicates a medication route of administration, a medication frequency of administration and a form of a medication. The process of FIG. 6 terminates at step 607.

The system, process and image menus of FIGS. 1-6 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Functions, processes or activities connected with FIGS. 1-6 may be performed automatically or alternatively, wholly or partially in response to manual interaction. A medication information acquisition system according to invention principles is applicable in any fields involving the need to gather information from multiple sources. The system is of particular use in a hospital setting by providers required to collect home medications from a patient especially when a patient has a prior medication history available. Further, any of the functions and steps provided in the system of FIG. 1 may be implemented in hardware, software or a combination of both and may reside on one or more processing devices located at any location of a network linking the FIG. 1 elements or another linked network including another intra-net or the Internet.

What is claimed is:

1. A medication information acquisition system for automatically acquiring patient medication information from a plurality of different sources, comprising:
an acquisition processor for, in response to user command, automatically interrogating a plurality of different information sources for acquiring and collating medication data to provide patient medication history data indicating medications a patient received prior to admission to a healthcare provider facility, said plurality of different information sources including at least two of,
(a) a pharmacy benefit management system,
(b) a healthcare information system indicating medications a patient was receiving at the most recent time of discharge of said patient from a healthcare provider facility and
(c) medication information derived by questioning said patient; and
a display processor for initiating generation of data representing a display image identifying said medications said patient received prior to admission and enabling a user to individually select medications to be continued or canceled.

2. A system according to claim 1, wherein
said display image includes user selectable elements enabling a user to at least one of, (i) access data identifying said patient medication history, (ii) initiate display of data indicating candidate medications to add to medications said patient is receiving prior to admission and (iii) initiate display of an image supporting a user in capturing information provided by a patient concerning medications the patient is taking.

3. A system according to claim 1, wherein
said display image includes a first image area identifying said patient medication history data indicating medications said patient received prior to admission and a second image area indicating medications said patient is receiving and enabling a user to individually select medications to be added from said first image area to said second image area and delete a medication from said second image area.

4. A system according to claim 1, wherein
said acquisition processor identifies and removes data indicating replicated medications to provide from said patient medication history data comprising a consolidated list of medications said patient received prior to admission to a healthcare provider facility.

5. A system according to claim 4, wherein
said consolidated list of medications indicates at least one of, (a) a date on which a prescription for a corresponding medication was last filled and (b) a last healthcare facility discharge date at which said patient was receiving a corresponding medication.

6. A system according to claim 4, wherein
said acquisition processor identifies and removes said data indicating replicated medications by matching data identifying medications using a reference database associating brand and generic names of a medication.

7. A system according to claim 1, wherein
said acquisition processor sorts a list of candidate medications available to add to medications said patient is receiving prior to admission in response to predetermined sorting criteria to provide a sorted medication list and
said display image indicates said sorted medications.

8. A system according to claim 1, wherein
said display image includes data fields enabling a user to search a list of candidate medications available to add to medications said patient is receiving prior to admission in response to user entered search criteria.

9. A system according to claim 1, wherein
said display image includes data fields enabling a user to enter data indicating at least one of, (a) a drug name, (b) a drug strength and (c) a prescription.

10. A system according to claim 9, wherein
said prescription indicates at least one of, (a) a medication route of administration, (b) a medication frequency of administration and (c) a form of a medication.

11. A system according to claim 1, wherein
said display processor initiates generation of data representing a display image identifying said medications said patient received prior to admission by including medications based on accuracy factors associated with acquired medication information.

12. A system according to claim 11, wherein
said accuracy factors include at least two of, (a) age of the data, (b) the original source of the data and (c) reliability of the patient.

13. A system according to claim 11, wherein
said display processor initiates generation of data representing a display image identifying said medications said patient received prior to admission by including medications in response to an estimated accuracy indicating likelihood a patient was taking the medication concerned exceeding a predetermined threshold value.

14. A system according to claim 1, including
a sorting processor for sorting said medications identified in said display image by at least one of, (a) data of prescription and (b) date of last filling of a prescription.

15. A medication information acquisition system for automatically acquiring patient medication information from a plurality of different sources, comprising:
an acquisition processor for, in response to user command, automatically interrogating a plurality of different information sources for acquiring and collating medication data and identifying and removing data indicating replicated medications to provide a consolidated list of medications said patient received prior to admission to a healthcare provider facility, said plurality of different information sources including at least two of,
(a) a pharmacy benefit management system,
(b) a healthcare information system indicating medications a patient was receiving at the most recent time of discharge of said patient from a healthcare provider facility and
(c) medication information derived by questioning said patient; and
a display processor for initiating generation of data representing a display image identifying said medications said patient received prior to admission and enabling a user to individually select medications to be continued or canceled.

16. A system according to claim 15, wherein
said display image includes user selectable elements enabling a user to at least one of, (i) access data identifying said patient medication history, (ii) initiate display of data indicating candidate medications to add to medications said patient is receiving prior to admission and (iii) initiate display of an image supporting a user in capturing information provided by a patient concerning medications the patient is taking and
said display image includes a first image area identifying said patient medication history data indicating medications said patient received prior to admission and a second image area indicating medications said patient is receiving and enabling a user to individually select a medication to be added from said first image area to said second image area and delete a medication from said second image area.

17. A medication information acquisition system for automatically acquiring patient medication information from a plurality of different sources, comprising:
an acquisition processor for, in response to user command, automatically interrogating a plurality of different information sources for acquiring and collating medication data and to provide a consolidated list of medications said patient received prior to admission to a healthcare provider facility, said plurality of different information sources including,
(a) a pharmacy benefit management system,
(b) a healthcare information system indicating medications a patient was receiving at the most recent time of discharge of said patient from a healthcare provider facility and
(c) medication information derived by questioning said patient; and
a display processor for initiating generation of data representing a display image identifying said medications said patient received prior to admission and enabling a user to individually select medications to be continued or canceled, said display image including a first image area identifying said patient medication history data indicating medications said patient received prior to admission and a second image area indicating medications said patient is receiving and enabling a user to individually select a medication to be added from said first image area to said second image area and delete a medication from said second image area.

18. A system according to claim 17, wherein
said display image includes user selectable elements enabling a user to at least one of, (i) access data identifying said patient medication history, (ii) initiate display of data indicating candidate medications to add to medications said patient is receiving prior to admission and (iii) initiate display of an image supporting a user in capturing information provided by a patient concerning medications the patient is taking.

19. A system according to claim 17, wherein
said acquisition processor identifies and removes data indicating replicated medications to provide said consolidated list of medications said patient received prior to admission to a healthcare provider facility, said plurality of different information sources including.

20. A medication information acquisition system for automatically acquiring patient medication information from a plurality of different sources, comprising:
an acquisition processor for, in response to user command, automatically interrogating a plurality of different information sources for acquiring and collating medication data to provide patient medication history data indicating medications a patient received prior to admission to a healthcare provider facility, said plurality of different information sources including at least two of,
(a) a pharmacy benefit management system,
(b) a healthcare information system indicating medications a patient was receiving at the most recent time of discharge of said patient from a healthcare provider facility and
(c) medication information derived by questioning said patient; and
a display processor for initiating generation of data representing a display image including user selectable elements enabling a user to display in a first image area items including at least one of, (i) data identifying said patient medication history, (ii) data indicating candidate medications to add to medications said patient is receiving prior to admission and (iii) elements supporting a user in capturing information provided by a patient concerning medications the patient is taking.

21. A system according to claim 20, wherein
said display image enables a user to navigate through said items in said first image area while concurrently displaying a second image area indicating medications said patient is receiving and enabling a user to individually select medication data to be added from said first image area to said second image area and delete a medication from said second image area.
